(19) United States
(12) Patent Application Publication
(10) Pub. No.: US 2004/0253510 A1
(43) Pub. Date: Dec. 16, 2004

(54) Aliovalent protective layers for active metal anodes

(75) Inventors: Lutgard C. De Jonghe, Lafayette, CA (US); Yevgeniy S. Nimon, Danville, CA (US); Steven J. Visco, Berkeley, CA (US)

Correspondence Address: BEYER WEAVER & THOMAS LLP, P.O. BOX 778, BERKELEY, CA, 94704-0778, US

(73) Assignee: PolyPlus Battery Company

(21) Appl. No.: 10/861,336

(22) Filed: Jun. 3, 2004

Related U.S. Application Data
(60) Provisional application No. 60/476,143, filed on Jun. 4, 2003.
(60) Provisional application No. 60/482,997, filed on Jun. 27, 2003.

(51) Int. Cl. H01M 2/16; H01M 4/38; H01M 4/46; H01M 4/40

(52) U.S. Cl. 429/137; 429/246; 429/231.6; 429/231.95; 429/231.9; 427/126.1

(57) ABSTRACT

Active metal anodes can be protected from deleterious reaction and voltage delay in an active metal anode-solid cathode battery cell can be significantly reduced or completely alleviated by coating the active metal anode (e.g., Li) surface with a thin layer of a chemical protective layer incorporating aliovalent (multivalent) anions on the lithium metal surface. Such an aliovalent surface layer is conductive to Li-ions but can protect lithium metal from reacting with oxygen, nitrogen or moisture in ambient atmosphere thereby allowing the lithium material to be handled outside of a controlled atmosphere, such as a dry room. Particularly, preferred examples of such protective layers include mixtures or solid solutions of lithium phosphate, lithium metaphosphate, and/or lithium sulphate. These protective layers can be formed on the Li surface by treatment with diluted solutions of the following acids: H₃PO₄, HPO₃ and H₂SO₄ or their acidic salts in a dry organic solvent compatible with Li by various techniques. Such chemical protection of the Li or other active metal electrode significantly enhances active metal electrode protection and reduces the voltage delay due to protected anode's improved stability toward the electrolyte.

### CROSS-REFERENCE TO RELATED APPLICATIONS

This application claims priority from U.S. Provisional Application No. 60/476,143 filed Jun. 4, 2003, titled ACTIVE METAL BATTERY ELECTRODE PROTECTION; and claims priority from U.S. Provisional Application No. 60/482,997, titled ALLEVIATION OF VOLTAGE DELAY IN ACTIVE METAL ANODE-SOLID CATHODE BATTERY CELLS, filed Jun. 27, 2003; the disclosures of which are incorporated by reference herein in their entirety for all purposes.

### BACKGROUND OF THE INVENTION

1. Field of the Invention

The present invention relates generally to surface treatments to facilitate the processing and/or stability of an active metal (e.g. lithium) or alloy anode, such as for incorporation in electrochemical devices, and to alleviate the voltage delay sometimes associated with the use of active metal anodes in battery cells.

2. Description of Related Art

Lithium is an attractive material for use as an electrode component in electrochemical devices, such as batteries and capacitors, due to its very high energy density and low equivalent weight. However, lithium is highly reactive in ambient conditions and thus requires special handling during processing. Typically, lithium battery manufacture is conducted in inert environments in order to guard against degradation of lithium until it is hermetically sealed within a battery cell container.

Even with these precautions, lithium may detrimentally react with incompatible materials in the processing environment. For example, rechargeable lithium metal batteries have been prone to cell cycling problems. On repeated charge and discharge cycles, lithium “dendrites” have been found to gradually grow out from the lithium metal electrode, through the electrolyte, and ultimately contact the positive electrode. This causes an internal short circuit in the battery, rendering the battery unusable after a relatively few cycles. While cycling, lithium electrodes may also grow “mossy” deposits which can dislodge from the negative electrode and thereby reduce the battery's capacity. To address these problems, some researchers have proposed that the electrolyte facing side of the lithium negative electrode be coated with a “protective layer.” Several methods may be envisioned for producing such a protective layer, but the processing methods by which such layers are produced may not be compatible with the lithium metal.

Some research has focused on “nitridation” of the lithium metal surface as a means for protecting lithium electrodes. In such process, a bare lithium metal electrode surface is reacted with a nitrogen plasma to form a surface layer of polycrystalline lithium nitride (Li₃N). This nitride layer conducts lithium ions and at least partially protects the bulk lithium of the negative electrode from a liquid electrolyte. A process for nitriding lithium battery electrodes it is described in R&D Magazine, September 1997, p 65 (describing the work of S. A. Anders, M. Dickinson, and M. Rubin at Lawrence Berkeley National Laboratory). Unfortunately, in addition to structural and electrical problems with this approach, lithium nitride decomposes when exposed to moisture. While lithium metal batteries employ nonaqueous electrolytes, it is very difficult to remove all traces of moisture from the electrolyte. Thus, trace moisture will ultimately compromise the protective properties of the lithium nitride.

Other preformed lithium protective layers have been contemplated. Most notably, U.S. Pat. No. 5,314,765 (issued to Bates on May 24, 1994) describes a lithium electrode containing a thin layer of sputtered lithium phosphorus oxynitride (“LiPON”) or related material. LiPON is a single ion (lithium ion) conducting glass. It is typically deposited by reactive sputtering of a lithium phosphate in the presence of nitrogen. The nitrogen, however, attacks the lithium surface, thereby making the process of direct deposition of the glass film impossible.

Other examples of potential protective layers may include the deposition of polymer layers that involve solvents or monomers that are incompatible with lithium.

Another problem encountered with some active metal anode battery cells is voltage delay. In particular, a voltage delay is often experienced upon load of some active metal anode primary battery cells, such as active metal-transition metal oxide battery cells, for example in connection with pulse discharge of lithium-silver vanadium oxide batteries.

The high reactivity of lithium metal renders it prone to reaction with chemical agents with which it comes in contact. When lithium metal is used as a negative electrode material, reaction with agents in the fabrication or storage environment or components of a battery cell in which the lithium anode is incorporated may result in the formation of passivating films on the lithium surface that have a deleterious effect on the performance of the lithium electrode. As a result of the formation of resistive passivating films, the cell may not be able to achieve a minimum of required operating voltage for a certain period of time. The period of time necessary for a cell to achieve minimum operating voltage following application of an initial load or change in the load is referred to as the cell's voltage delay.

Battery cells composed of a lithium metal anode and a silver vanadium oxide cathode have found use in a variety of applications, in particular in implantable medical devices, such as defibrillators. However, these cells are known to be susceptible to voltage delay thought to be caused by the formation of a passivating film on the anode surface on reaction with constituents of the electrolyte used in these cells, typically inorganic alkali metal (e.g., lithium) salts dissolved in aprotic organic solvents, such as ethers, for example 1,2-dimethoxyethane (DME) or organic carbonates, for example propylene carbonate (PC). Voltage delay is generally undesirable, but is particularly problematic in applications where the voltage delay could render the device powered by the battery ineffective for its intended purpose.

The voltage delay issue has been addressed by lithium-silver vanadium oxide battery cell developers, including, in particular, Wilson Greatbatch Technologies, Inc. of East Amherst, N.Y. In several issued US patents including U.S. Pat. Nos. 6,068,950, 6,274,269, 6,203,942, 6,511,772, 6,096,447, 6,200,701 and 6,537,698 all assigned to Wilson Greatbatch Ltd., the disclosures of which are incorporated herein by reference in their entirety and for all purposes, Gan et al. describe and claim the use of phosphate additives in nonaqueous electrolytes of alkali metal anode-solid cathode battery cells. The patents present data showing alleviation of voltage delay in cells incorporating from 0.005 to 0.02M phosphate in the form of trimethyl phosphate or triphenyl phosphate. Electrochemical cells and methods of reducing voltage delay with nonaqueous electrolytes incorporating from 0.001 to 0.04M phosphate additives are disclosed and claimed.

Nothwithstanding these developments, there is significant room for improvement in procedures and compositions that would facilitate handling and enhance operation of metallic lithium, lithium alloy or other active metal or metal alloys.

### SUMMARY OF THE INVENTION

Work in the laboratories of the present applicants indicates that enhanced surface layers that improve anode protection from deleterious agents and/or alleviate voltage delay in active metal-solid cathode battery cells can be achieved by techniques other than those known to date. Fabrication processing and successful operation of active metals as battery electrodes is enhanced by the provision of such a protective layer. Battery cells and structures formed by these novel techniques have electrochemical characteristics suggesting improved performance capabilities.

The present invention alleviates the problem of reaction of lithium or other active metals with incompatible processing environments by creating a chemical protective layer incorporating aliovalent (multivalent) ions on the lithium metal surface. Such an aliovalent surface layer is conductive to Li-ions but can protect lithium metal from reacting with oxygen, nitrogen or moisture in ambient atmosphere thereby allowing the lithium material to be handled outside of a controlled atmosphere, such as a dry room. Production processes involving lithium (or other active metal anode materials) are thereby very considerably simplified. One example of such a process is the processing of lithium to form negative electrodes for lithium metal batteries.

In preferred embodiments, the chemical protective layer incorporates mixtures or solid solutions of active metal salts, for example phosphates, metaphosphates or their reduction products and sulfates, for example Li₃PO₄ and Li₂SO₄. It may be formed by a liquid, vapor or gas phase surface treatment with a chemical precursor. It may be formed ex situ or in situ (for example, by incorporation of a protective layer-forming chemical precursor in an electrolyte) in a battery cell. Application of the chemical protective layer may be followed by application of additional protective layers, for example, a glassy protective layer such as LiPON, and facilitates this process.

Voltage delay in an active metal-solid cathode battery cell can be significantly reduced or completely alleviated by coating the active metal anode (e.g., Li) surface with a thin aliovalent protective layer with active metal-ion conductivity in accordance with the present invention. These protective layers can be formed on the Li surface by treatment with diluted solutions of the following acids: H₃PO₄, HPO₃ and H₂SO₄, and their acidic salts, in binary or ternary mixtures in a dry organic solvent compatible with Li, for instance in 1,2-DME. Alternatively, the protective layers may be deposited physically on the Li surface. Such aliovalent chemical protection of the Li or other active metal electrode significantly reduces the voltage delay due to the protected anode's improved stability toward the electrolyte when the treated electrode is subsequently incorporated into a battery cell.

The material of the protective layer should have very low solubility in the battery electrolyte. Lithium phosphate, lithium metaphosphate and lithium sulfate satisfy this requirement for typical electrolytes. For instance, the solubility of lithium phosphate in a solution of 1.0 M LiClO₄ in a mixture of PC-DME (50:50 by volume) is less than 5.0 mg/l. Addition of the Li or other active metal salt or salts corresponding to the protective film material to the electrolyte system can also be used to saturate the electrolyte with the already minimally soluble protective film material further suppressing dissolution of the protective film in the electrolyte.

In addition, the use of acid mixtures for Li surface treatment can also be beneficial by increasing the ionic conductivity of the protective layer. Presence of ions with different valences in the protective layer (i.e., protective layers incorporating aliovalent ions) can increase its conductivity because they result in the formation of additional mobile ionic point defects in the crystalline lattice.

The ex situ protective layer forming treatment may also be combined with or supplemented by incorporation into the electrolyte system of additives that can react with any exposed Li (or other active metal) surface to form a protective layer based on lithium phosphate or phosphate and sulfate. Many applications require not just one continuous full discharge, but rather a partial discharge followed by storage and further discharge or even several discharge-rest-discharge iterations. Incorporation of protective layer forming additives in the electrolyte provides the capability to repair any cracks or other damage occurring to the ex situ formed protective layer during partial discharge or over the course of multiple discharge events. Such additives as H₃PO₄ and HPO₃ acids, LiH₂PO₄ and Li₂HPO₄ acidic salts in combination with each other or sulfuric acid or its active metal salts, or NR₄H₂PO₄ where R is (C₄H₉) or other alkyls may be used for this purpose.

In one aspect, the invention relates to a composition comprising a lithium or other active metal or alloy layer coated with a chemical protective layer incorporating aliovalent ions. The protective layer is at least transiently physically and chemically stable in an ambient air environment and protects the active metal from further chemical reaction, and which protective layer conducts ions of the active metal.

In another aspect, the invention relates to an electrochemical cell incorporating such an active metal anode coated with a chemical protective layer incorporating aliovalent ions and a solid cathode.

In another aspect, the invention relates to a method of providing an aliovalent chemical protective layer on lithium or other active metal. The method includes contacting the lithium metal with precursors of the protective layer and conducting a reaction involving the precursors to form the aliovalent chemical protective layer on the lithium metal.

These and other features of the invention will be further described and exemplified in the drawings and detailed description below.

### BRIEF DESCRIPTION OF THE DRAWINGS

FIG. 1 illustrates a protected active metal anode in accordance with one embodiment of the present invention.

FIG. 2 illustrates a battery cell incorporating a protected active metal anode in accordance with one embodiment of the present invention.

### DETAILED DESCRIPTION OF THE PREFERRED EMBODIMENTS

In the following description, the invention is presented in terms of certain specific compositions, configurations, and processes to help explain how it may be practiced. The invention is not limited to these specific embodiments. For example, while much of the following discussion focuses on lithium systems, the invention pertains more broadly to the class of active metal battery systems (e.g., batteries having negative electrodes of alkali and alkaline earth metals). Examples of specific embodiments of the invention are illustrated in the accompanying drawings. While the invention will be described in conjunction with these specific embodiments, it will be understood that it is not intended to limit the invention to such specific embodiments. On the contrary, it is intended to cover alternatives, modifications, and equivalents as may be included within the scope and equivalents of the appended claims.. In the following description, numerous specific details are set forth in order to provide a thorough understanding of the present invention. The present invention may be practiced without some or all of these specific details. In other instances, well known process operations have not been described in detail in order not to unnecessarily obscure the present invention.

Introduction

Active metal anodes can be protected from deleterious reaction and voltage delay in an active metal-solid cathode battery cell can be significantly reduced or completely alleviated by coating the active metal anode (e.g., Li) surface with a thin aliovalent protective layer with active metal-ion conductivity using chemical treatment of the active metal surface. Particularly preferred examples of such protective layers for a lithium metal anode, for example, include binary or ternary mixtures or solid solutions of lithium phosphate, lithium metaphosphate, and lithium sulphate. These protective layers can be formed on the Li surface by treatment with diluted solutions of the following acids: H₃PO₄, HPO₃ and H₂SO₄, and their acidic salts, in binary or ternary mixtures in a dry organic solvent compatible with Li. Alternatively, the protective layers may be deposited physically on the Li surface. Such chemical protection of the Li or other active metal electrode significantly reduces the voltage delay due to the protected anode's improved stability toward the electrolyte when the treated electrode is subsequently incorporated into a battery cell. The invention provides various implementations of the invention including methods of coating active metal anodes with a protective film, protected active metal anodes, protected active metal anode-solid cathode battery cells and associated electrolytes.

For clarity of presentation, the invention is described herein primarily with reference to Li anodes. However, it should be understood that suitable anodes may be composed of other active metals and alloys as described herein, and the protective films or reagents described as containing Li may correspondingly contain such other active metals or alloys.

Protected Anodes

Protected anodes in accordance with the present invention are composed of an active metal anode material (e.g., Li) having a surface coated with a thin protective layer composed of material incorporating active metal aliovalent salts with active Li-ion conductivity. Particularly preferred examples of such materials are combinations of lithium phosphate, lithium metaphosphate, and lithium sulfate. Such chemical protection of the Li or other active metal electrode significantly reduces the voltage delay due to the protected anode's improved stability toward the electrolyte. In one embodiment, the protective film includes Li₃PO₄ and Li₂SO₄. The presence of ions with different valences in the protective layer (i.e., protective layers having aliovalent ions) can be beneficial by increasing its ionic conductivity because they result in the formation of additional mobile ionic point defects in the crystalline lattice.

Active metals are highly reactive in ambient conditions and can benefit from a barrier layer when used as electrodes. They are generally alkali metals such (e.g., lithium, sodium or potassium), alkaline earth metals (e.g., calcium or magnesium), and/or certain transitional metals (e.g., zinc), and/or alloys of two or more of these. The following active metals may be used: alkali metals (e.g., Li, Na, K), alkaline earth metals (e.g., Ca, Mg, Ba), or binary or ternary alkali metal alloys with Ca, Mg, Sn, Ag, Zn, Bi, Al, Cd, Ga, In. Preferred alloys include lithium aluminum alloys, lithium silicon alloys, lithium tin alloys, lithium silver alloys, and sodium lead alloys (e.g., Na₄Pb). A preferred active metal electrode is composed of lithium.

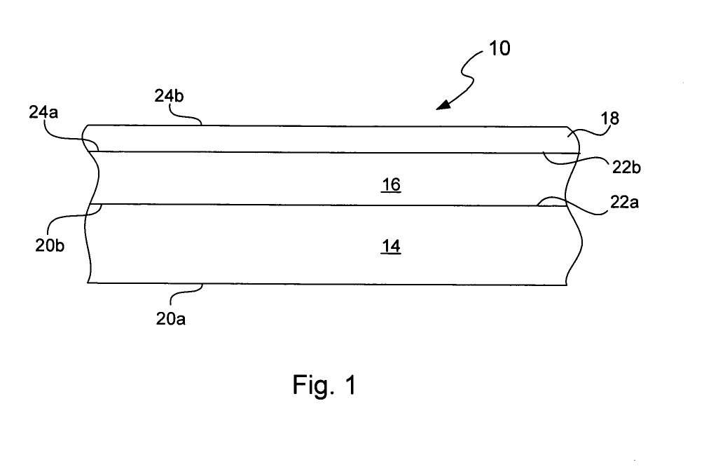

FIG. 1 illustrates a negative electrode (anode) 10 in accordance with this invention. Shown in cross-section, negative electrode 10 includes three components; a backing layer 14, an active metal layer 16 and a protective layer 18. The backing layer 14 includes a first surface 20A which is exposed to the ambient and a second surface 20B which intimately contacts the active metal layer 16. Backing layer 14 will typically serve as a current collector. Active metal layer 16 includes a first surface 22A which forms the interface with backing layer 14. It also includes a second surface 22B which intimately contacts protective layer 18. In turn, protective layer 18 includes a first surface 24A which contacts second surface 22B of the active metal layer 16. Finally, protective layer 18 includes a second surface 24B which is exposed to the ambient. The interfaces at surfaces 22A and 22B of metal layer 16 should be sufficiently continuous or intimate that moisture, air, electrolyte, and other agents from the ambient are prevented from contacting alkali metal 16. In addition, the interface at first surface 22A should provide a low resistance electronic contact between backing layer 14 and the active metal layer 16.

Backing layer 14 is provided on the side of negative electrode 10 which faces away from the electrolyte. It should be electronically conductive and unreactive to moisture, gases in the atmosphere (e.g., oxygen and carbon dioxide), electrolytes and other agents it is likely to encounter prior to, during, and after fabrication of a battery. In addition, backing material 14 should be compatible with the metal in layer 16 at potentials encountered in the battery. In this regard, the material in backing layer 18 should not easily migrate into or otherwise detrimentally affect the electrochemical properties of the active metal layer 16. Examples of suitable materials for backing layer 14 include foils or other thin metal layers of copper, stainless steel, nickel, zinc, chromium, and compatible alloys thereof. In addition, such metals may be provided as metallization layers on plastics such as polyethylene terephthalate (PET), polypropylene, polyethylene, polyvinylchloride (PVC), polyolefins, polyimides, etc.

In an alternative embodiment, conductive backing layer 14 is replaced with a non-electronically conductive outer layer such as a second protective layer. In this embodiment, a current collector or terminal must still be affixed to the alkali metal electrode. This may take the form of a metal tab or other electronically conductive member that extends beyond the protective layers.

Most generally, the active metal layer 16 can comprise any metal, any mixture of metal capable of functioning as a negative electrode. However, the protective layers of this invention will find most use in protecting highly reactive metals such as alkali metals and alkaline earth metals.

As indicated above, protective layer 18 should form a continuous and intimate interface with the active metal layer 16 to protect it from various agents in the environment.

Protective Layer Composition

Creation of a thin, chemical protective layer composed of material incorporating aliovalent ions (e.g., aliovalent anions Li₃PO₄ and Li₂SO₄) on the active metal (e.g., lithium) surface helps to solve the problem of reaction of the lithium surface with incompatible processing environment, in particular, in ambient conditions containing oxygen, nitrogen or moisture, or with gaseous nitrogen during direct deposition of a glassy protective layer (e.g., LiPON) onto lithium by reactive sputtering of lithium phosphate, and to alleviate voltage delay.

The chemical protective layer 18 is composed of a Li-ion (or other active metal ion) conducting film incorporating aliovalent ions. Particularly preferred examples of such protective layers include binary or ternary mixtures or solid solutions of lithium phosphate, lithium metaphosphate and lithium sulphate. These protective layers can be formed on the Li surface by treatment with diluted solutions of the following acids: H₃PO₄, HPO₃ and H₂SO₄ and their acidic salts, in binary or ternary mixtures in a dry organic solvent compatible with Li, for instance in 1,2-DME. Alternatively, the protective layers may be deposited physically on the Li surface. Fabrication techniques for the protective films are described further below.

The use of acid mixtures for Li surface treatment can be beneficial by increasing the ionic conductivity of the protective layer relative to protective layers incorporating only ions of a single valence. Presence of ions with different valences (multivalent or “aliovalent” ions) in the protective layer can increase its ionic conductivity because they result in the formation of additional mobile ionic point defects in the crystalline lattice.

Such coatings may be permanent or transient, depending on the quality of the lithium surface being coated. However, even a coating providing transient protection (e.g., a few hours or even minutes) may provide a significant advantage in handling and processing highly reactive materials such as lithium.

Glassy Protective Layer

Where the invention is implemented as a negative electrode for a lithium metal battery it may be desirable to provide a further physical protective coating on the electrode. As noted above, the chemical protective layer of the present invention advantageously provides protection for the lithium from deleterious reactions with incompatible processing environments (for example, ambient air atmospheres containing oxygen, nitrogen or moisture) by creating a chemical protective layer on the lithium metal surface. This allows the lithium material to be handled outside of a controlled atmosphere, such as a dry room, facilitating application of a physical protective layer, such as a glassy or amorphous material that is gap-free, substantially impervious to air and moisture, non-swellable and conductive to active metal ions of the active metal comprised in layer 16. Examples of such glassy or amorphous metal ion conductor protective layer materials are provided in U.S. Pat. No. 6,025,094, previously incorporated by reference, for example. A specific example is LiPON.

It is further contemplated that aliovalent protective layer precursors may be incorporated in the electrolytes of battery cells having lithium metal (or other active metal) electrodes with glassy protective layers, such as LiPON. The presence of such precursors allows for the formation of a “healing” chemical protective layer in the event of a crack or other defect or damage to the glassy protective layer by reaction with the lithium surface exposed by such a crack in situ.

Battery Cells

Protected electrodes in accordance with the present invention may be incorporated in active metal-based battery cells such as are described in Applicant's prior US Patents and patent applications including U.S. Pat. No. 6,025,094, previously incorporated by reference, and the Gan et al. patents noted herein and also previously incorporated by reference.

Batteries of this invention may be constructed according to various known processes for assembling cell components and cells. Generally, the invention finds application in any cell configuration. The exact structure will depend primarily upon the intended use of the battery unit. Examples include thin film with porous separator, thin film polymeric laminate, jelly roll (i.e., spirally wound), prismatic, coin cell, etc.

Generally, batteries employing the negative electrodes of this invention will be fabricated with an electrolyte. The electrolyte may be in the liquid, solid (e.g., polymer), or gel state. It may be fabricated together with the negative electrode as a unitary structure (e.g., as a laminate). Such unitary structures will most often employ a solid or gel phase electrolyte.

Electrolytes for active metal anode-solid cathode battery cells are well known and are described, for example, in U.S. Pat. No. 6,025,094, entitled PROTECTIVE COATINGS FOR NEGATIVE ELECTRODES, to Visco et al., incorporated by reference herein in its entirety and for all purposes and the above-referenced Gan et al. patents, previously incorporated by reference. The base electrolytes described therein may be used in cells in accordance with the present invention. For example, individual or mixed organic carbonate or individual or mixed ether solvents with a variety of lithium salts, including LiPF₆, LiAsF₆, LiBF₄, LiTFSI and LiClO₄ may be used. A typical example is 1.0 M LiAsF₆ dissolved in a 50:50, by volume, mixture of PC (propylene carbonate) and DME (1,2 dimethoxyethane).

The negative electrode is spaced from the positive electrode, and both electrodes may be in material contact with an electrolyte separator. Current collectors contact both the positive and negative electrodes in a conventional manner and permit an electrical current to be drawn by an external circuit. In a typical cell, all of the components will be enclosed in an appropriate casing, plastic for example, with only the current collectors extending beyond the casing.

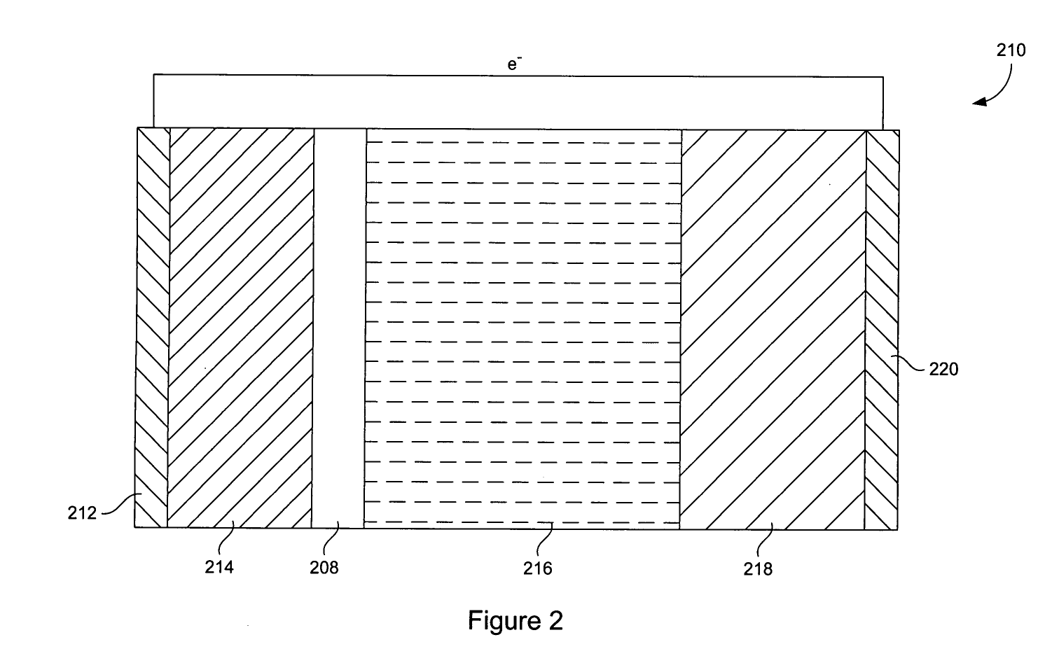

Referring now to FIG. 2, a cell 210 in accordance with a preferred embodiment of the present invention is shown. Cell 210 includes a negative current collector 212, which is formed of an electronically conductive material. The current collector serves to conduct electrons between a cell terminal (not shown) and a negative electrode 214 (such as lithium) to which current collector 212 is affixed. Negative electrode 214 is made from lithium or other active metal such as described above with reference to FIG. 1, and includes a protective layer 208 formed opposite current collector 212. If the bonding layer does not diffuse into the active metal, there may be a separate layer of the bonding material (not shown) between the negative electrode and the barrier layer. Barrier layer 208 contacts an electrolyte in an electrolyte region 216. As mentioned, the electrolyte may be liquid, gel, or solid (e.g., polymer). An example of a solid electrolyte is polyethylene oxide. An example of gel electrode is polyethylene oxide containing a significant quantity of entrained liquid such as an aprotic solvent.

In the case of a liquid electrolyte, an optional separator in region 216 prevents electronic contact between the positive and negative electrodes. A positive electrode 218 abuts the side of separator layer 216 opposite negative electrode 214. Because electrolyte region 216 is an electronic insulator and an ionic conductor, positive electrode 218 is ionically coupled to but electronically insulated from negative electrode 214. Finally, the side of positive electrode 218 opposite electrolyte region 216 is affixed to a positive current collector 220. Current collector 220 provides an electronic connection between a positive cell terminal (not shown) and positive electrode 218.

Current collector 220, which provides the current connection to the positive electrode, should resist degradation in the electrochemical environment of the cell and should remain substantially unchanged during discharge and charge. In one embodiment, the current collectors are sheets of conductive material such as aluminum or stainless steel. The positive electrode may be attached to the current collector by directly forming it on the current collector or by pressing a pre-formed electrode onto the current collector. Positive electrode mixtures formed directly onto current collectors preferably have good adhesion. Positive electrode films can also be cast or pressed onto expanded metal sheets. Alternately, metal leads can be attached to the positive electrode by crimp-sealing, metal spraying, sputtering or other techniques known to those skilled in the art. Some positive electrodes can be pressed together with the electrolyte separator. In order to provide good electrical conductivity between the positive electrode and a metal container, an electronically conductive matrix of, for example, carbon or aluminum powders or fibers or metal mesh may be used.

When a liquid electrolyte is employed, a separator may, as mentioned, occupy all or some part of electrolyte compartment 216. If a separator is used, preferably it will be a highly porous/permeable material such as felt, paper, or microporous plastic film. It should also resist attack by the electrolyte and other cell components under the potentials experienced within the cell. Examples of suitable separators include glass, plastic, ceramic, and porous membranes thereof among other separators known to those in the art. In certain specific embodiments, the separator is Celgard 2300 or Celgard 2400 available from Hoechst Celanese of Dallas, Tex.

In some embodiments of the invention, the cell may be characterized as a “thin film” or “thin layer” cell. Such cells possess relatively thin electrodes and electrolyte separators. Preferably, the positive electrode is no thicker than about 300 μm, more preferably no thicker than about 150 μm, and most preferably no thicker than about 100 μm. The negative electrode preferably is no thicker than about 200 μm and more preferably no thicker than about 100 μm. Finally, the electrolyte separator (when in a fully assembled cell) is no thicker than about 100 μm and more preferably no thicker than about 40 μm.

The present invention can be used with any of a number of battery systems employing a (highly reactive) active metal electrode, such as lithium or other alkali metal. The batteries may be primary or secondary cells. For example, any positive electrode that may be used with lithium metal or lithium ion batteries can be used with this invention. These include lithium manganese oxide, lithium cobalt oxide, lithium nickel oxide, lithium vanadium oxide, etc. Mixed oxides of these protective layers may also be employed such as lithium cobalt nickel oxide. For example, suitable positive electrodes (cathodes) to couple with the protected anodes in such battery cells include: metal oxide based electrodes (e.g., silver vanadium oxide), elemental sulfur-based electrodes, lithium polysulfide based electrodes, metal sulfide based electrodes (e.g., FeS₂, TiS₂, CuS, FeS), metal oxide based electrodes (e.g., MnO₂, CuO, Ag₂CrO₄, MoO₃), lithiated metal oxide or phosphate based electrodes (e.g.,LiₓCoO₂, LiₓNiO₂, LiₓMn₂O₄ and LiFePO₄).

One specific application of the electrodes of this invention is in lithium-sulfur batteries. Sulfur positive electrodes and metal-sulfur batteries are described in U.S. Pat. No. 5,686,201 issued to Chu on Nov. 11, 1997, for example, incorporated by reference for all purposes.

The material of the aliovalent protective layer should have very low solubility in the battery electrolyte. Lithium phosphate, lithium metaphosphate and lithium sulfate satisfy this requirement for typical electrolytes. For instance, the solubility of lithium phosphate in a solution of 1.0 M LiClO₄ in a mixture of PC-DME (50:50 by volume) is less than 5.0 mg/l. Addition of the Li or other active metal salt or salts corresponding to the protective film material to the electrolyte system can also be used to saturate the electrolyte with the already minimally soluble protective film material further suppressing dissolution of the protective film in the electrolyte.

A particular example of a battery cell type in which the present invention is applicable is lithium-silver vanadium oxide battery cells, such as are used in implantable defibrillators. These cells combine a lithium anode, in this case protected with an aliovalent protective film, such as lithium phosphate/lithium sulfate, in accordance with the present invention; a silver vanadium oxide cathode; and a liquid electrolyte, such as 1.0 M LiAsF₆ dissolved in a 50:50, by volume, mixture of PC (propylene carbonate) and DME (1,2 dimethoxyethane).

Fabrication Methods

Anode protective films in accordance with the present invention can be made by treating the surface of an active metal (e.g., Li) anode by bringing it into contact with a dilute acidic solution which reacts with the active metal to form a thin layer of an inorganic compound with active metal-ion conductivity. The film should ideally have low solubility in the electrolyte to be used.

In one embodiment, the treatment takes place outside a battery cell before its assembly (i.e., ex situ). The ex situ treatment may be combined with in situ treatment (i.e., in a battery cell) for repair of any damage to the ex situ formed protective film following incorporation into a battery cell. In situ treatment, either alone or in combination with ex situ treatment, is also possible and is accomplished by addition of protective film forming additives to the battery cell's electrolyte.

The film may be formed by contacting the active metal (e.g., Li) surface with a diluted solution of the following acids: H₃PO₄, HPO₃ and their active metal acidic salts (i.e., XH₂PO₄, X₂HPO₄ where X is an atom of the active metal (e.g., Li)) in binary or ternary mixtures or solid solutions thereof or with one or more of H₂SO₄ and LiHSO₄ in a dry organic solvent compatible with the active metal. Suitable solvents include 1,2-DME, THF or other cyclic or linear ethers, and hydrocarbons such as hexane and heptane. Tetra alkyl ammonium salts of phosphoric acid, such as NR₄H₂PO₄, where R is an alkyl group (e.g., C₄H₉) may also be used in combination with other agents as noted above. In one embodiment, the acids are H₃PO₄ and H₂SO₄. The use of acid mixtures for Li surface treatment can be beneficial by increasing the ionic conductivity of the protective layer. Presence of ions with different valences in the protective layer can increase its conductivity because they result in the formation of additional mobile ionic point defects in the crystalline lattice.

The anode is composed of an active metal or alloy in any suitable form. Li foils, for example, 125 micron foil available from Cyprus Foote Mineral Company, is one example. Other examples include lithium binary or ternary alloys with magnesium, calcium, aluminum, tin, silicon, indium, and other metals.

The concentration of the diluted acid solutions in both ex situ and in situ treatments is generally less than 10% by weight, for instance less than 1% by weight, and is preferably in the ppm range, for example between about 50 to 5000 ppm, more preferably about 100 to 2500 ppm. Phosphoric acid is generally used in higher concentration than sulfuric acid. In one specific example, dry DME containing about 1500 ppm of anhydrous phosphoric acid and about 200 ppm of concentrated sulfuric acid (96-98%) may be used.

Immediately prior to treatment, the Li surface is preferably cleaned and prepared, for example by polishing. The polishing may be conducted with Tyvec fabric (Model 1509 B, available from Tyvec), for example. Other suitable surface cleaning and preparation techniques include pressing and rolling, and cleaning by means of a rotating brush.

Surface treatment may be conducted using a variety of techniques. Particularly preferred treatments involve contacting of the lithium surface with a protective film forming agent in the liquid phase, for example by dipping, painting, spraying, etc. Unsubstituted acids are generally preferred for ex situ treatment as they provide the most rapid reaction with the active metal surface and formation of the protective film. Duration of the treatment is for as long as is necessary to form an effective protective film, and may be from about 10 seconds to 10 minutes, for example, about two minutes for the composition and concentrations of acids noted above. Effective protective films of this type will generally have a thickness sufficient to substantially prevent reaction of electrolyte solvents, such as, from reacting with the lithium (or other active metal) anode to form the resistive layer (e.g., lithium oxide) responsible for the voltage delay. The thickness is generally at least 10 A, for example in the range from about 10 to 5000 Å, and preferably in the range from about 10 to 500 Å, or 50 to 100 Å.

Alternatively, the protective film may be formed by a technique such as sputtering, e-beam deposition, chemical vapor deposition and laser ablation of the material(s) of the protective film.

Following Li surface reaction with acids and formation of a protective layer, the Li surface is generally cleaned by rinsing with dry solvent, such as DME and then dried. All described operations are conducted in an inert atmosphere, such as an Ar-filled glove box or processing chamber.

Alternatively, the protective function of the layer may be further enhanced by additional exposure, in combination or sequentially, to chemical agents including liquid or gaseous oxyhalides, or solvated metal salts including aliovalent metal halides, active metal dithionates, active metal chloroaluminates, aliovalent cation organnometallics, or aliovalent orthosilicates and their derivatives, such as methasilicates, alone or in combination. Specific chemical agents include thionyl chloride, lithium tetrachloroaluminate, aluminum chloride, tetraalkyl ammonium salts.

The ex situ formed aliovalent protective films of the present invention are believed to have advantages over the formation of some single anion protective films in situ. First of all, the quality, durability and performance characteristics of the protective film formed is believed to be improved relative to in situ formed films since the ex situ reaction conditions can be carefully controlled. In situ formation of a protective film requires that the protective film forming additive compete with electrolyte components to react with the lithium surface. As a result, the film formed may actually be composed of a mixture of materials (e.g., lithium phosphate and lithium oxide and/or carbonates or other solid reaction products of electrolyte components with lithium) with greater electrical resistance than a pure phosphate or phosphate/sulfate protective film and/or may be structurally weaker and thus more susceptible to damage during cell discharge. Ex situ treatment of a Li surface in accordance with the present invention allows for an appropriate choice of the treatment agent concentration, the type of a carrier solvent used, and the duration of the treatment. As a result, the formation of a thin, dense, and conductive protective layer can be achieved.

Also, since the film forming additives are continuously present in the electrolyte, it may be difficult to control film thickness. The reaction between the phosphate additive and the Li surface will likely continue until the complete consumption of the additive (or the active Li metal) in the cell. Most likely, the mechanism of this continuous process is associated with possibility of proton transport from the phosphate compounds dissolved in electrolyte through the formed layer of solid reaction products to the Li surface. Evolution of the gaseous hydrogen formed during this reaction can lead to the partial breakdown of the layer of solid reaction products and intense reaction of exposed Li with dissolved phosphate compounds. The thick layer of the reaction product can also crack because of mechanical stresses. As a result, Li surface will be exposed and the reaction will continue. The result may be films that are thicker and more resistive than are necessary. Ex situ formation of a protective film on the anode surface prior to incorporation if the battery cell has the advantages of being able to reliably form a high quality film of known composition and thickness that will immediately protect the anode from deleterious reaction with electrolyte components when the anode is incorporated in a battery cell.

In addition, the protective films having aliovalent ions, formed ex situ or in situ, in accordance with the present invention have the above-noted enhanced conductivity characteristics relative to single anion (i.e., single valence anion) films. Further, ex situ treatment of the Li anode requires neither compatibility of the treatment agent with the components of the electrolyte (nonaqueous solvents, supporting salts, and dissolved active cathode material), nor electrochemical stability of the treatment agent at positive potentials corresponding to the cell cathode.

It is also possible using an ex situ treatment technique to treat the anode surface with agents leading to formation of aliovalent lithium phosphate, lithium phosphonate or lithium sulfate containing compounds having crosslinkable groups, followed by chemical or radiation (in particular, UV) initiated polymerization of these compounds on the Li surface. Robust protective layers with increased conductivity can be formed as a result. The following groups in the phosphonate and phosphate compounds and, accordingly, the following compounds having such groups, for example, can be used for ex situ Li surface treatment: amino group (NH₂),tri-m-tolyl phosphate and (1-aminomethyl) phosphonic acid; halide group, 2-chloroethylphosphonic acid and tris(2-chloroethyl) phosphate; hydroxyl (OH) group, (2-oxo-propyl)-phosphonic acid di-sodium salt and naphthol AS phosphate; carbenyl (C═C) group, ethylene glycol methacrylate phosphate; azo (N═N) group, 1-naphthyl 4-phenylazophenyl phosphate; cyano (CN) group, barium 2-cyanoethylphosphate hydrate; carbonyl (C═O) group, the example is tris-(tetrahydrofurfuryl) phosphate.

As noted above, in one embodiment, the ex situ formation of the aliovalent protective film on the anode may be combined with incorporation into the electrolyte system of a battery cell of additives that can react with any exposed Li (or other active metal) surface to form a protective layer composed of aliovalent active metal salts, for example binary or ternary combinations of lithium phosphate, metaphosphate and sulfate. Many applications require not just one continuous full discharge, but rather a partial discharge followed by storage and further discharge or even several discharge-rest-discharge iterations. Incorporation of protective layer forming additives in the electrolyte provides the capability to repair any cracks or other damage occurring to the ex situ formed protective layer during partial discharge or over the course of multiple discharge events. Such additives as H₃PO₄ and HPO₃ acids, LiH₂PO₄ and Li₂HPO₄ acidic salts in combination with each other or sulfuric acid or its active metal salts, and NR₄H₂PO₄ where R is (C₄H₉) or other alkyls may be used for this purpose.

In an alternative embodiment of the invention, ex situ treatment of the Li anode with phosphoric acid or another reactive phosphate compound may be followed by in situ treatment with sulfuric acid or other reactive sulfate compound added into the battery electrolyte. In this case, the protective layer forms before the cell is filled with an electrolyte, and can be modified with sulfate compounds which are present in the electrolyte.

Electrolytes for active metal anode-solid cathode battery cells are well known and are described, for example, in U.S. Pat. No. 6,025,094, entitled PROTECTIVE COATINGS FOR NEGATIVE ELECTRODES, to Visco et al., incorporated by reference herein in its entirety and for all purposes and the above-referenced Gan et al. patents, previously incorporated by reference. The base electrolytes described therein may be used in cells in accordance with the present invention. For example, individual or mixed organic carbonate or individual or mixed ether solvents with a variety of lithium salts, including LiPF₆, LiAsF₆, LiBF₄, LiTFSI and LiClO₄ may be used. A typical example is 1.0 M LiAsF₆ dissolved in a 50:50, by volume, mixture of PC (propylene carbonate) and DME (1,2 dimethoxyethane).

Acidic salts are preferred as anode protective film forming additives in situ as they are generally less corrosive to and reactive with other battery cell components are less likely to produce thicker, higher impedance layers over the long periods of exposure of the anode surface to the electrolyte in battery cell. Particularly preferred are aliovalent mixtures, for example a mixture of acidic salts LiH₂PO₄ and LiHSO₄, which, as noted above, can be beneficial by increasing the ionic conductivity of the resulting protective layer. The film forming additives are added to the electrolyte in an amount sufficient to repair any damage done to the active metal ion-conducting protective film coating the active metal anode during subsequent discharge of the cell. For example, less than 1% by weight is generally used,, and preferably in the ppm range, for example between about 50 to 5000 ppm, more preferably about 100 to 2500 ppm.

In some embodiments, the electrolyte may further be supplemented by the addition of the Li or other active metal salt or salts corresponding to the protective film material(s). Such additives can be used to saturate the electrolyte with the already minimally soluble protective film material further suppressing dissolution of the protective film in the electrolyte.

Techniques and equipment for forming and coating lithium metal substrates, for example for use as negative battery electrodes, are known in the art and will not be further described here in order not to unnecessarily obscure the present invention. For example, U.S. Pat. No. 6,025,094, entitled PROTECTIVE COATINGS FOR NEGATIVE ELECTRODES, to Visco et al., incorporated by reference herein in its entirety and for all purposes, describes lithium metal battery electrode and cell fabrication techniques and materials applicable to implement the present invention.

### Alternative Embodiments

While the present invention is described herein primarily in terms of aliovalent protective films comprising a combination of active metal salts containing aliovalent anions, it should be noted that alternative embodiments of the present invention may have aliovalent protective films comprising a combination of active metal salts containing aliovalent cations.

### EXAMPLES

The examples presented here are intended to better illustrate the invention as described herein and are non-limiting.

### Example 1

### Production of Protective Aliovalent Lithium Phosphate/Lithium Sulfate Layer by Li Surface Treatment with Phosphoric and Sulfuric Acid Mixture

A Li electrode surface (125 micron foil from Cyprus Foote Mineral Company) was treated with dry DME containing 1500 ppm of anhydrous phosphoric acid and 200 ppm of concentrated sulfuric acid (96-98%). Just before treatment, the Li surface was polished with Tyvec fabric (1509 B). Surface treatment was conducted by dipping of the Li electrode having surface area of about 2.0 cm² into a 20 ml flask filled with the acid containing solution. Duration of the treatment was two minutes. After the Li surface reaction with acids and formation of a protective layer, the Li surface was rinsed with pure dry DME and dried. All described operations were conducted in Ar-filled glove box.

### Example 2

### Further Treatment

The protective function of the layer is further enhanced by dipping the electrode as coated above per Example 1 in a solution of thionyl chloride.

Conclusion

Although the foregoing invention has been described in some detail for purposes of clarity of understanding, it will be apparent that certain changes and modifications may be practiced within the scope of the appended claims. It should be noted that there are many alternative ways of implementing both the process and compositions of the present invention. For example, while the invention is primarily described with reference to lithium systems, the invention pertains more broadly to the class of active metal battery systems (e.g., batteries having negative electrodes of alkali (e.g., sodium and potassium) and alkaline earth (e.g., calcium and magnesium), metals and alloys. Accordingly, the present embodiments are to be considered as illustrative and not restrictive, and the invention is not to be limited to the details given herein, but may be modified within the scope and equivalents of the appended claims.

The entire disclosures of all references cited herein are incorporated by reference for all purposes.

What is claimed is:

1. An active metal negative electrode, comprising:
an active metal anode material; and
an active metal ion-conducting protective film coating the anode material comprising aliovalent ions.

2. The electrode of claim 1, wherein the aliovalent protective film comprises a combination of active metal salts containing aliovalent anions selected from the group consisting of active metal phosphate, active metal metaphosphate and combinations thereof.

3. The electrode of claim 2, wherein the anode protective film further comprises an active metal sulfate.

4. The electrode of claim 3, wherein the anode comprises Li and the protective film consists essentially of Li₃PO₄ and Li₂SO₄.

5. The electrode of claim 1, wherein the active metal is selected from the group consisting of alkali or alkaline earth metals or alloys thereof.

6. The electrode of claim 1, wherein the active metal is an alkali metal or alloy thereof.

7. The electrode of claim 6, wherein alkali metal is selected from the group consisting of lithium, sodium and potassium.

8. The electrode of claim 7, wherein the alkali metal is lithium.

9. The electrode of claim 5, wherein the active metal is an alkaline earth metal or alloy thereof.

10. The electrode of claim 9, wherein the alkaline earth metal is selected from the group consisting of barium, beryllium, magnesium and calcium.

11. The electrode of claim 10, wherein the alkaline earth metal is calcium.

12. The electrode of claim 1, wherein the protective film has a thickness between about 10 and 500 Å.

13. The electrode of claim 1, wherein the protective film has a thickness between about 50 and 100 Å.

14. The electrode of claim 1, further comprising a substantially impervious layer on the protective film, the substantially impervious layer comprising a glassy or amorphous metal ion conductor.

15. An electrochemical cell, comprising:
an active metal anode; and
a solid cathode;
wherein the active metal anode is coated with an active metal ion-conducting protective film comprising a combination of active metal salts containing aliovalent ions.

16. The cell of claim 15, wherein the combination of active metal salts of the anode protective film comprises a salt selected from the group consisting of active metal phosphate, active metal metaphosphate and combinations thereof.

17. The cell of claim 16, wherein the anode protective film further comprises an active metal sulfate.

18. The cell of claim 16, wherein the anode comprises Li and the protective film consists essentially of Li₃PO₄ and Li₂SO₄.

19. The cell of claim 15, wherein the active metal is selected from the group consisting of alkali or alkaline earth metals or alloys thereof.

20. The cell of claim 18, wherein the alkali metal is lithium.

21. The cell of claim 15, wherein the protective film has a thickness between about 10 and 500 Å

22. The cell of claim 15, wherein the protective film has a thickness between about 50 and 100 Å

23. The cell of claim 15, wherein the cathode comprises a material selected from the group consisting of metal oxide based electrodes, elemental sulfur-based electrodes, lithium polysulfide based electrodes, metal sulfide based electrodes, metal oxide based electrodes, lithiated metal oxide based electrodes and lithiated metal phosphate based electrodes.

24. The cell of claim 23, wherein the cathode comprises a material selected from the group consisting of silver vanadium oxide, S, LiₓS, FeS₂, TiS₂, CuS, FeS, MnO₂, CuO, Ag₂CrO₄, MoO₃), LiₓCoO₂, LiₓNiO₂, LiₓMn₂O₄ and LiFePO₄.

25. The cell of claim 24, wherein the cathode comprises silver vanadium oxide.

25. The cell of claim 15, further comprising a non-aqueous electrolyte.

26. The cell of claim 25, wherein the electrolyte comprises a solvent selected from the group consisting of individual and mixed organic carbonates, and individual and mixed ethers, with an active metal salt.

27. The cell of claim 26, wherein the anode comprises lithium and the electrolyte comprises a lithium salt selected from the group consisting of LiPF₆, LiAsF₆, LiBF₄, LiTFSI and LiClO₄.

28. The cell of claim 27, wherein the electrolyte is 1.0 M LiAsF₆ dissolved in a 50:50 by volume mixture of PC (propylene carbonate) and DME (1,2 dimethoxyethane).

29. The cell of claim 25, wherein the electrolyte further comprises one or more anode protective film forming agents in an amount effective to form an active metal ion-conducting aliovalent protective film coating the active metal anode material in situ.

30. The cell of claim 15, wherein the cell is a primary cell.

31. The cell of claim 15, wherein the cell is a secondary cell.

32. A method of forming a protective film on an active metal negative electrode, comprising:
providing an active metal anode material;
forming an active metal ion-conducting protective film on the active metal anode material, the film comprising a combination of active metal salts containing aliovalent ions.

33. The method of claim 32, wherein the combination of active metal salts containing aliovalent ions of the anode protective film comprises a combination of active metal salts containing aliovalent anions selected from the group consisting of active metal phosphate, active metal metaphosphate and combinations thereof.

34. The method of claim 33, wherein the anode protective film further comprises an active metal sulfate.

35. The method of claim 34, wherein the anode protective film consists essentially of Li₃PO₄ and Li₂SO₄.

36. The method of claim 32, wherein the film is formed by contacting the anode material with anode protective film forming agents in an amount effective to form an active metal ion-conducting aliovalent protective film coating the active metal anode material.

37. The method of claim 36, wherein the anode protective film forming agents are selected from the group consisting of H₃PO₄, HPO₃, XH₂PO₄, X₂HPO₄ and NR₄H₂PO₄ and mixtures thereof and mixtures thereof with one or more agents selected from the group consisting H₂SO₄ and LiHSO₄, where X is an atom of the active metal and R is an alkyl group.

38. The method of claim 37, wherein X is Li and R is C₄H₉.

39. The method of claim 37, wherein the one or more anode protective film forming agents are H₃PO₄ and H₂SO₄.

40. The method of claim 32, wherein the protective film is formed ex situ prior to incorporation of the anode into a battery cell.

41. The method of claim 40, wherein the anode material is contacted with the one or more anode protective film forming agents by a technique selected from the group consisting of dipping, spraying and painting.

42. The method of claim 32, further comprising, following formation of the protective film, treating the protected anode surface with a solvent selected from the group consisting of liquid oxyhalides, non-metallic oxides, non-metallic halides and mixtures thereof.

43. The method of claim 41, wherein the solvent is thionyl chloride.

44. The method of claim 32, wherein the protective film is formed in situ after incorporation of the anode into a battery cell.

45. The method of claim 32, further comprising incorporating the protected anode in a battery cell, the battery cell comprising an electrolyte comprising one or more protective film forming agents in an amount effective to form an active metal ion-conducting aliovalent protective film on any active metal exposed by damage done to the active metal ion-conducting protective film coating the active metal anode during subsequent discharge of the cell.
